(19) United States
(12) Patent Application Publication
(10) Pub. No.: US 2006/0000296 A1
(43) Pub. Date: Jan. 5, 2006

(54) Synchronization of sample and data collection

(76) Inventor: Jason Patrick Salter, San Francisco, CA (US)

Correspondence Address: Janah & Associates, P.C., 650 Delancey Street, Suite 106, San Francisco, CA, 94107, US

(21) Appl. No.: 10/883,912

(22) Filed: Jul. 2, 2004

(51) Int. Cl. B01L 9/06; G01N 1/28; B01L 9/00

(52) U.S. Cl. 73/863.01; 73/864.91; 73/863.31; 422/104

(57) ABSTRACT

A sample collector to collect samples has a chassis with a receptacle that is sized to receive a container, and a restraint positioned about the receptacle to restraint the container in the receptacle. The restraint has an open position that allows a container to be inserted into, or released from, the receptacle, and a locked position in which the container is locked in and cannot be removed from the receptacle. A controller determines a status signal, and in response to the status signal, sends to the restraint, either of (i) an open signal to set the restraint to the open position, (ii) a lock signal to set the restraint to the locked position, or (iii) a stand-by signal to maintain the open or locked position of the restraint.

### BACKGROUND

Embodiments of the present invention relate to the collection, testing and evaluation of samples.

In the analysis, identification, and discovery processes, samples are collected from humans and animals for evaluation in the field or in a laboratory. For example, in the treatment of diseases, biological sample are collected for evaluation and testing. In the collection process, it is desirable to accurately identify and associate a sample with a particular donor (i.e. specific human or animal origin). Additional data that may be required to be associated with the sample can include the date and time of collection, the location of collection, and demographic and personal or descriptive information about the donor. The collected data should also be accurately linked to the sample. Inaccurate identification or inaccurate association can lead to false identification, improper diagnosis, or erroneous treatment of the donor. Proper sample identification can also reduce the risk of improper use of a collected sample, for example, erroneous identification of a specimen blood type in a transplantation operation can lead to the rejection and ultimate fatality of a organ identified by a particular blood type.

However, conventional sample collection systems and methods allow numerous opportunities for errors to occur during the collection process. For example, in the collection of blood in a hospital, a doctor fills out a paper form requesting a particular test to be performed on an individual. The individual carries the paper form to a blood lab, where a phlebotomist reviews the document and selects appropriate containers, which are typically Vacutainers® Becton, Dickinson and Company, N.J., USA. In the collection process, the operator inserts a needle into a sample donor, which is connected to a tube that feeds a secondary needle that is inserted into a container. A negative pressure in the container sucks in blood to fill the container. Thereafter, the operator selects a second container and repeats the procedure to fill it, and so on, until a specific number of containers are filled to contain the requisite amount of blood needed for a prescribed test. Each container may require different sample sizes, or is made from different materials, or is pre-filled with different sample modifying agents, and consequently, the operator has to select the correct containers. Also, before or after the containers are filled, the operator has to print out suitable labels that specify the patient name, doctor, and type of test to be performed, and adhere the labels on the correct containers. In the busy hospital environment, the operator is often distracted during sample collection, and as a result, can select the wrong types of containers or remove the secondary needle from a container before it is properly filled. When a larger number of sample are taken from one donor in a number of different containers, the chances of mislabeling individual containers is also more likely. In addition, when a number of different blood withdrawals are being simultaneously conducted, there is always a possibility that the containers are inadvertently associated with the wrong patient, leading to an erroneous diagnosis or treatment of that patient.

The correlation of a sample with the erroneous donor becomes increasingly probable when a large number of sample are taken from a group of separate donors, especially in a field environment. In the diagnosis and prevention of epidemics, operators are sent out into the field to retrieve large numbers of sample from different donors. For example, in the outbreak of SARS, thousands of sample were collected from people across wide rural areas of China; and in outbreaks of mad cow disease, millions of brain tissue sample are collected from slaughtered cows. In such field situations, it becomes more likely that a sample will be inadvertently associated with the wrong donor. Also, the possibility of mislabeling an individual container in a large set is more likely with the increased number of containers and donors. This can lead to false determination of an outbreak region, resulting in the failure to quickly identify and contain the sources of outbreak of an epidemic, and eventually leading to the loss of many lives and substantial economic repercussions. Improper sample identification can also increase the risk of inadvertent exposure to sample contaminated with a hazardous material, germ or virus.

The accuracy of correlating a sample with the correct donor becomes even more important when the collected samples are processed in automated robotic systems. Automated robotic systems with inventory control software (example: LIMS—laboratory information management system) allow rapid and efficient testing of large collections of sample. However, the automated testing process is entirely dependent upon the accuracy of sample identification and correlation with the proper source.

Reducing the number of times and duration a sample is handled is also desirable because each instance of sample handling is an opportunity for a mistake or accident to happen. Minimization of human contact with collected sample increase safety. Additionally, a reduction in sample handling reduces time and cost in sample collection, processing, and testing. Reducing the number of times information related to a particular sample is transcribed is also highly desirable because each instance of transcription of information introduces an opportunity for error. A device that allows information to be entered only once greatly reduces potential errors and lowers operating costs.

It is further desirable to ensure that the sample is collected in a sufficient quantity for the intended testing procedure. Most testing procedures require a minimum amount of sample for accurate results. When sample are returned for testing because there is an insufficient material to carry out the required test—substantial time, money, and effort is wasted. Additionally, a new sample must be collected when information on a particular donor is critical. Obtaining the second sample is time consuming, expensive, and stressful for the donor, and can also be difficult if the donor's location is no longer known.

Thus, it is desirable to have a sample collection system that reduces errors in the collection of sample. It is further desirable to have a system capable of collecting the desired amount of a sample in a container without improper termination of the collection process. It is also desirable to increase the accuracy of correlation of containers and donors, especially when collecting large numbers of sample. It is further desirable to collect field sample in outlying areas without inadvertently mislabeling of the sample. It is also desirable to reduce the number of times and duration a sample is handled. It is further desirable to ensure that samples are collected in sufficient quantity for their intended tests. Further, it is desirable to have a sample collection system capable of minimizing the number of times sample information needs to be entered or transcribed.

### SUMMARY

A sample collector to collect sample has a chassis with a plurality of receptacles in the chassis. Each receptacle is sized to receive a container and has a restraint positioned about the receptacle to restraint the container in the receptacle. The restraint has an open position that allows a container to be inserted into, or released from, the receptacle, and a locked position in which the container cannot be removed from the receptacle. A controller is also provided to determine at least one status signal, and in response to the status signal, send to the restraint, either of (i) an open signal to set the restraint to the open position, (ii) a lock signal to set the restraint to the locked position, or (iii) a stand-by signal to maintain the open or locked position of the restraint.

A method of collecting sample in the sample collector comprises placing a container in the receptacle in the chassis. The container is restrained in the receptacle by setting the restraint to the locked position in which the restraint locks-in the container. A sample may be provided in the container. The container is released by setting the restrain to the open position when the container is filled with the sample and any other required data collection and/or status signales have been completed.

### DRAWINGS

These features, aspects, and advantages of the present invention will become better understood with regard to the following description, appended claims, and accompanying drawings which illustrate exemplary features of the invention:

FIG. 1 is a perspective schematic view of an embodiment of a sample collector;

FIG. 2 is a perspective partial sectional view of another version of a sample collector and receptacle;

FIG. 3 is a perspective partial sectional view of yet another type of receptacle;

FIG. 4 is a sectional side view of a receptacle with a container inside, an associated container detector, restraint, weight sensor, and label reader;

FIG. 5 is a sectional side view of another type of receptacle with a container inside, an associated container detector, restraint, weight sensor, and label reader;

FIGS. 6A and 6B are sectional side views of another type of receptacle with a container inside and an associated restraint in the open and closed positions, respectively;

FIG. 6C is a perspective view of an annular clasp having a locking slot and ID tag that can be slipped over a container;

FIG. 7 is a sectional side view of another type of receptacle with a container inside and an associated restraint;

FIG. 8 is a schematic of an embodiment of a controller of the sample collector;

FIG. 9 is a block diagram of the hierarchal control structure of a computer program of the controller of FIG. 8;

FIG. 10 is a flowchart of an embodiment of a sample collection process;

FIG. 11 is a flowchart of an embodiment of the control of the LEDs of the sample collector;

FIG. 12 is a perspective schematic view of a chair station with an exploded enlarged diagram of the control face of the sample collector attached to the chair station;

FIG. 13 is a perspective schematic view of an enclosed mobile collector station; and

FIG. 14 is a perspective schematic view of a hand held collector station.

### DESCRIPTION

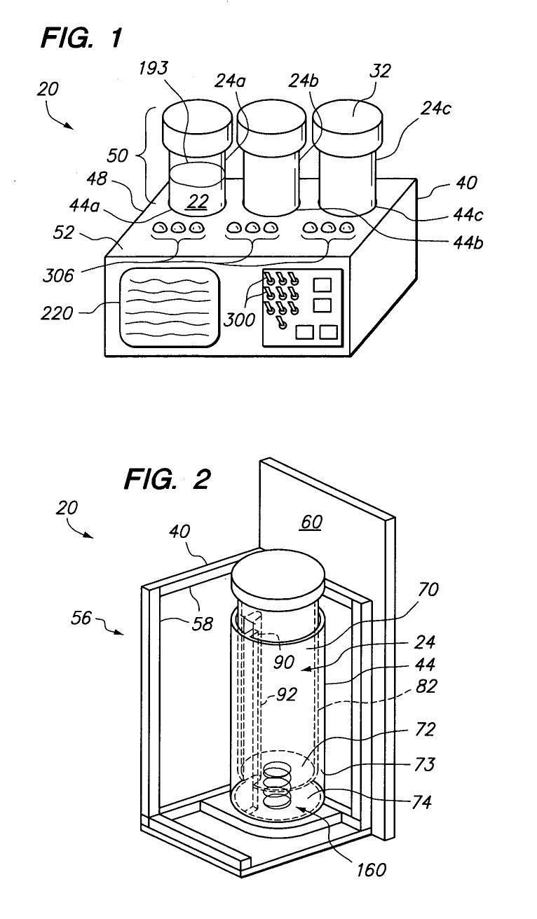

An embodiment of a sample collector 20 to collect one or more samples 22 in predefined containers 24, is for example, shown in FIG. 1. The samples 22 collected may include, for example, biological specimens such as blood, urine, feces, bodily fluids, soft tissue and bacterial cultures; or other specimens such as water, minerals, air or soil. The sample 22 can be attached, adsorbed, or stabilized within the containers 24 by using special surfaces, reagents, or adsorbent materials. The containers 24 vary in size, shape, and contents, depending on the sample 22 being collected and the requirements of the testing or analysis process. For example, containers 24 for collecting blood typically comprise semi-transparent plastic tubes 28 sealed at their open end with a penetrable cap 32, and that enclose a volume maintained at sub-atmospheric pressure to collect the blood sample 22, such as for example, a Vacutainer® Becton, Dickinson and Company, N.J., USA. The containers 24 can be made in different sizes to collect different volumes of blood, varying both in length and diameter, and they can also be pre-loaded with different materials in the container. The pre-loaded materials can be, for example, heparin to inhibit coagulation of blood or sodium citrate. For most applications, the container 24 is also translucent or transparent to allow visual or optical determination of the level of sample 22 in the container.

The collector 20 comprises a chassis 40 with one or more receptacles 44 to receive the containers 24. The chassis 40 surrounds the receptacles 44 to provide structural integrity to the receptacle 44. In one version, the chassis 40 comprises a box 48 that has enclosed surfaces 52 that surround three receptacles 44a-c as shown in FIG. 1. The receptacles 44a-c are disposed in the box 48 so that when containers 24a-c are inserted in the receptacles, a portion 50 of each container 24a-c extends out of the box 48, to allow an operator to visually detect a sample level 193 of the sample 22 received in the container 24 is outside the box 48. The receptacles 44 can also receive a minimum portion of the container 24 that is necessary to secure the container in the receptacle so that the size of the collector 20 can be minimized for portable applications. FIG. 2 shows a sample collector 20 comprising an open frame 56 of cross-connected beams 58 without walls (not shown) that forms a rectangular or X-configuration which allows an operator to see the entire contents of the containers 24 within the open frame 56. Optionally, a shield 60 can also be mounted on the open frame 56 (as shown) to allow an operator to view the contents of containers 24 while obscuring the view of the containers 24 from the sample donor.

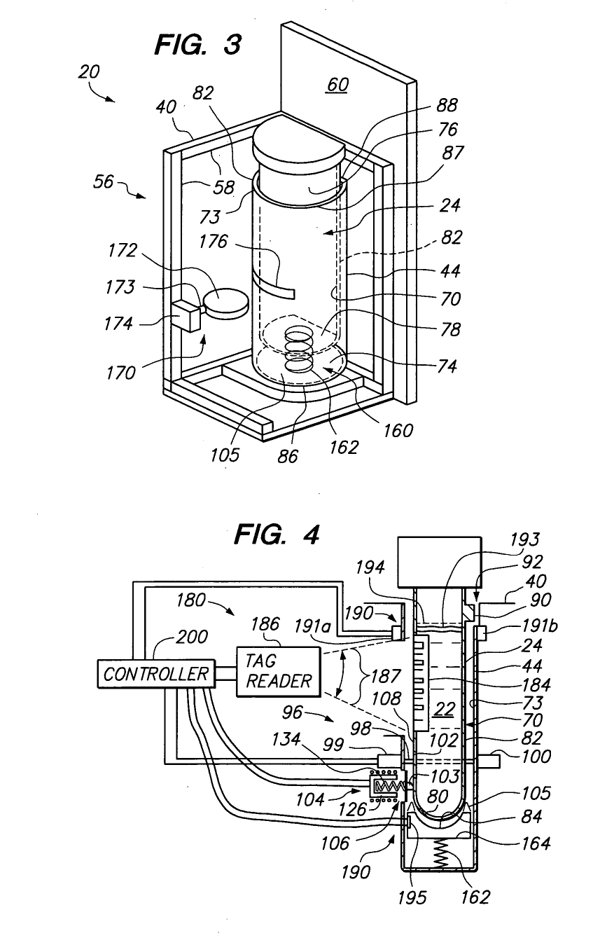

Each of the receptacles 44 in the chassis 40 is shaped and sized to receive a container 24. For example, the container 24 is a hollow cylinder 70 having a flat round end 72, as shown in FIG. 2, the receptacle 44 comprises an internal surface 73 that is also cylindrical in shape and that ends in a flat round bottom 74 that is shaped to receive. As another example, when the container 24 is a half-cylindrical tube 76 with a half-cylinder end 78, as shown in FIG. 3, the receptacle 44 has matching half-cylinder end 79. In a further example, when the container 24 is a hollow cylinder 70 having a rounded tapered end 80, the receptacle 44 is also shaped with cylindrical internal surfaces 73 that follow the contour of the external surfaces 82 of the cylinder 70 and has a rounded cup surface 84 that receives the rounded tapered end 80 of the cylinder 70, as shown in FIG. 4. Alternatively, the receptacle 44 can also be shaped with a tapered conical end (not shown) or with a reversed spherical end with a recessed dome (also not shown), to match corresponding shapes of the container 24.

The receptacle 44 can also guide the containers 24 so that each container 24 becomes oriented in a particular direction. For example, the receptacle 44 and container 24 can have matching asymmetric shapes so that the container 24 has a particular orientation when properly inserted in a receptacle, as shown in FIG. 3. In the version shown, the container 24 is a half-cylindrical tube 76 that fits into a receptacle 44 that is also shaped like a matching half-cylinder hollow 86. The asymmetric shaped receptacle 44 with a semi-circular rounded side 87 and a flat side 88 also holds the container 24 more securely by preventing rotational slippage. Instead of an asymmetric shape, the receptacle 44 can also have an orientation tab 90 that guides an orienting slot 92 in the body of the container 24 so that the container 24 always sits in the receptacle 44 facing a particular direction as shown in FIG. 2. Conversely, the orienting slot 92 can be located inside the receptacle 44 and the cylinder 70 of the container 24 can have an orientation tab 90 that fits into the orientation slot 92 (not shown). The orientation tab 90 can be an elongated track or a short protrusion as shown in FIGS. 2 and 4

In one version, a container detector 96 is provided about the receptacle 44 to detect the presence of a container 24 in the receptacle 44, as shown in FIG. 4. The container detector 96 can be a touch or pressure sensitive device mounted about the internal surfaces 73 of the receptacle 44 so that a container 24 inserted into the receptacle 44 comes in contact with the detector 96. A suitable touch sensor comprises a contact switch or electrical resistance device that generates a signal on being touched by a container 24. A suitable container detector 96 can also be an optical beam 98 that is broken (as shown), an electrical circuit that is opened or closed, or a secondary function of a sample sensor (such as a pressure sensitive sensor as described below) that indicates when a container 24 has been inserted sufficiently far into the receptacle 44. For example, as shown in FIG. 4, the container detector 96 can be a combination of a paired beam source 99 and beam receiver 100. The beam source 99 generates an optical beam 98 which passes through the empty volume of a receptacle 44 in which there is no container 24 to be received by the beam receiver 100. However, when a container 24 is inserted into the path of the beam 98, the body of the container itself, or a beam blocking tag 102 on the container 24 blocks the optical beam 98 from the beam receiver 100 to indicate detection of a container 24 in the receptacle 44. The container detector 96 generates a status signal comprising a container received signal which indicates if a container 24 is properly received in a receptacle 44. When the container 24 is improperly placed into the receptacle 44, the container detector 96 can also generate a container received signal that indicates that the container 24 is improperly placed into the receptacle 44 to allow ejection of the container 24.

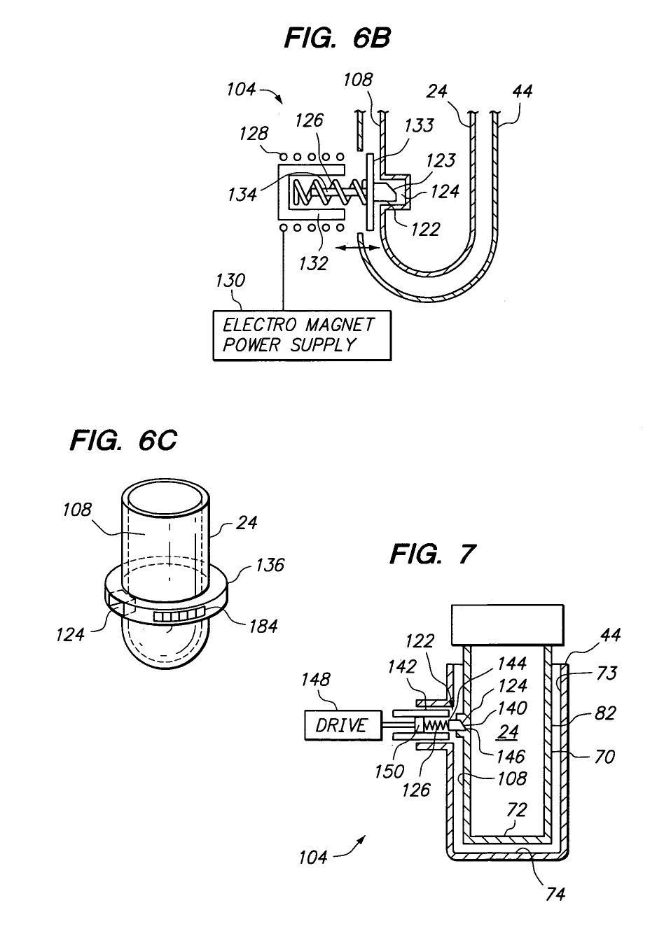

A restraint 104 is positioned about each receptacle 44 in the chassis 40 to restrain the container 24 in the receptacle, as for example, shown in FIGS. 4 to 7. Generally, the restraint 104 has an open position that allows a container 24 to be inserted into, or released from, the receptacle 44; and a locked position in which the container 24 is locked into and cannot be removed from the receptacle 44. The restraint can generate a status signal comprising a restraint status signal that contains information on the position and status of the restraint. One version of a restraint 104 that is positioned near the bottom portion 105 of the receptacle 44 in the chassis 40 to restrain the container 24, is shown in FIG. 4, FIGS. 6A (open position) and 6B (locked position). The restraint 104 comprises a locking pin 122 that is inserted into a corresponding locking slot 124 in the body of the container 24. The locking pin 122 and slot 124 are positioned to be on matching portions of the container 24 and receptacle 44. The locking pin 122 has a tapered end 123 that is oriented so that the slope of the taper faces the opening of the receptacle 44, such that during insertion of a container 24, the locking pin 122 is pushed aside by the downward force exerted by the downwardly pressed sidewall 108 of the container 24 on the tapered end 123, which in turn, generates a force against a locking spring 126 to push back the locking pin 122, as shown in FIG. 6A. When the container 24 has been inserted sufficiently deep into the receptacle 44, the locking pin 122 encounters a locking slot 124 and extends into it because the locking spring 126 expands outward from a compressed position exerting a biasing force on the locking pin 122, as shown in FIG. 6B. Removal of the container 24 is prevented when the locking pin 122 of the restraint 104 is set into the locked position in the locking slot 124. To retract the locking pin 122 to remove the container 24, an electromagnetic solenoid 128 is powered by an electromagnetic power supply 130, causing magnetization of the armature 132, which attracts and pulls back the metal disc 133 mounted on the axial pin 134 attached to the locking pin 122 to retract the pin 122. Thus, when the restraint 104 is set to the open position, the locking pin 122 is pulled out of the locking slot 124 and held in this position to allow the container 24 to be removed from the receptacle 44. Typically, the armature 132 is a metal disc 133, and optionally also the axial pin 134, are made from ferromagnetic materials, such as iron or ferrite materials. The axial pin 134 is sized to fit into, and slide in and out of, the locking spring 126.

While the locking slot 124 is shown as integral to the sidewall 108 of the container 24, the slot 124 can also be in an annular clasp 136 slipped over the sidewall 108 of the container 24 prior to insertion of the container 24 into the receptacle 44, as shown in FIG. 6C. Additionally, the annual clasp 136 may also have an ID tag 184 associated with it. The annular clasp 136 is useful when the containers 24 have a predetermined shape, such as a cylindrical shape, such as the aforementioned Vacutainers®.

In another version, the restrain comprises a clamp 106 having a pad 103 that grips the sidewall 108 of the container 24 with frictional forces shown in FIG. 4. The pad 103 is biased against the container 24 by a spring 105 that sits inside a spring housing 107 and pushes against the clamp 106. The container pushes aside the pad 103 when inserted into the receptacle until the pad 103 traverses the rounded tapered end 80 of the container and reaches the flat sidewall 108 where the spring 105 behind the pad 103 is fully compressed and firmly secures the container 24. To remove the container 24, it is rotated and eased around until the rounded tapered end 80 gradually slides over the pad allowing the spring to expand into the additional distance between the pad 103 and container sidewall 108, and thus, reducing the force exerted by the spring 105 via the pad 103 on the container 24 allowing its removal.

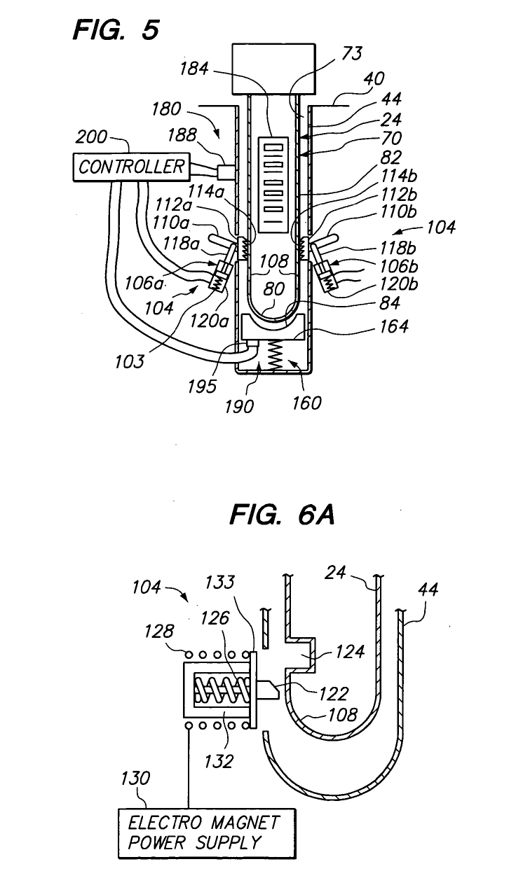

Another version of a restraint 104 comprises a pair of clamps 106a,b that grip opposing sides of the sidewalls 108 of containers 24, as shown in FIG. 5. The clamps 106a,b are oriented such that during insertion of a container 24, they are pushed aside and generates minimal friction (not shown). When removal of the container 24 is attempted with the restraint 104 set to the closed position (as shown), the sidewalls 108 of the container 24 pull the clamps 106a,b toward the container 24. The action of pulling the clamps 106a,b into the sidewall 108 of the container 24 generates a force sufficient for friction between the clamps 106a,b and the container 24 to inhibit removal of the container 24. In the version shown, the clamps 106a,b each comprise gripping pads 112a,b having a toothed surface 114a,b. The gripping pads 112a,b are connected to lever arms 110a,b that pivot on spring arms 118a,b, which are biased toward the container sidewall 108 by an spring enclosed within a solenoid 120a,b. To set the clamps into the open position the solenoid 120a,b retracts the lever arms 110a,b when activated.

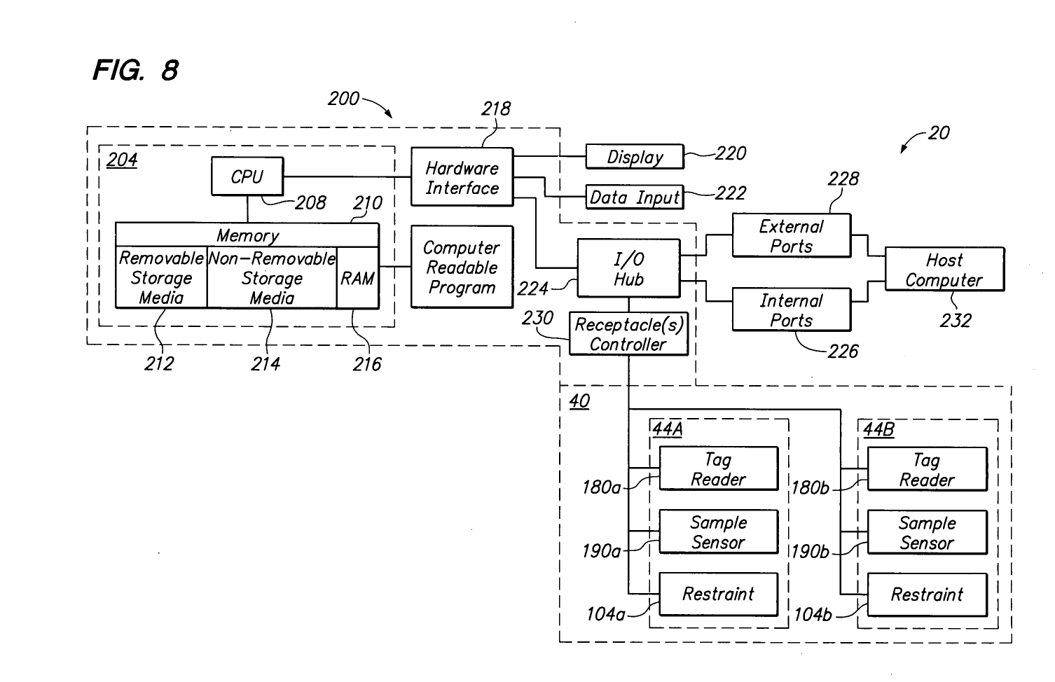

Another version of restraint 104, as shown in FIG. 7, comprises a locking wedge 140 that is spring biased against the sidewall 108 of the container 24. The locking wedge 140 is biased by a locking spring 126 that is inside a lock cylinder 142 and presses against a back face 144 of the locking wedge 140. The front face 146 of the locking wedge 140 is shaped so that the sidewall 108 of the container 24 when initially inserted into the receptacle 44, pushes the locking pin back into the lock cylinder 142 and compresses the locking spring 126. When the container 24 is inserted a sufficient distance into the receptacle, as shown in FIG. 7, the locking wedge 140 encounters a locking slot 124 that matches the shape of the wedge 140, causing the wedge 140 to become locked into the slot 124 to lock in the container 24. To allow removal of the container 24, a drive 148 is activated to withdraw a plunger 150 behind the locking spring 126, which retracts the locking spring 126 to withdraw the locking wedge 140 from the slot 124, thus, freeing the container 24 for removal.

An ejector 160 within the receptacle 44 can also be provided to eject a container 24 that is not properly inserted in the receptacle 44, of the wrong type, or upon completion of the sample collection process, as shown in FIGS. 2 thru 5. Generally, the ejector 160 comprises a compressible ejection spring 162 located at the bottom portion 105 of the receptacle 44. The ejector can also generate a status signal comprising an ejector signal containing information about the position and status of the ejector. Initially, when a container 24 is inserted in the receptacle 44, the flat round end 72 of the container 24 in FIG. 2, or the half-cylinder end 78 of the container 24 in FIG. 3, compresses the spring 162 until the container 24 is restrained by a restraint (not shown). Referring to FIGS. 4 and 5, the ejection spring 162 can also be mounted to press against a cup 164 which has a rounded cup surface 84 that receives the rounded end 80 of the container 24. The restraints 104 about the receptacle 44 prevent the container 24 from being pushed back upwards by the spring 162. When ejection of the container 24 is desired the restraints 104 are set to the open position to allow the ejection spring 162 to push back the container 24 upwards to eject the container from the receptacle.

A blocker 170 can also be used to block insertion of a container 24 in a receptacle 44. In one version, the blocker 170 comprises a blocking plate 172 that is connected to a drive shaft 173 powered by a blocking drive 174, as shown in FIG. 3 in the retracted position. The blocking plate 172 can be a circular disc, as shown, or any other shape that would operate to prevent the motion of the container 24 into the receptacle 44. The blocking plate 172 slides into position into the receptacle 44 through a blocking slot 176 when the blocking drive 174 is triggered by a blocking signal. Alternatively, a restraint 104 can also serve as a blocker 172 by being activated to be in a locked (or closed) position when the receptacle 44 is empty such that a container 24 cannot be inserted into the receptacle 44 once the restraint 104 is locked. The blocker can generate a status signal comprising a blocker signal that contains information about the position and status of the blocker.

A tag reader 180 is provided to read an identification (ID) tag 184 on a received container 24 containing information about the container. The tag reader 180 can be an optical sensor 186 that scans the ID tag 184 with a laser beam 187 that rapidly scans though a fixed viewing angle, as shown in FIG. 4. The tag reader 180 can also be bar code reader 188 that reads an ID tag 184 comprising a set of bar codes on the container 24 that forms the ID tag 184, as shown in FIG. 5. The orientation of the container 24 can be set to assist in allowing the tag reader 180 to read the ID tag 184. The ID tag 184 can contain information relating to an encoded and unique serial number and can also contain information about the type, size, properties, volume, manufacturer, or use of a particular container; and may also identify reagents that are maintained inside the container 24 for particular applications, for example, reagents that prevent blood from clotting. The ID tag 184 can also be pre-printed and affixed to the container 24 with information about the sample 22, such as the donor, the volume or weight of sample 22 to be collected, the location of collection, and other data that is associated with the donor. The ID tag 184 can also be a printed label, bar code or an RF tag. Data collected during sample collection can also be uploaded into the memory of the RF tag. The tag reader 180 generates a status signal comprising a container tag signal that contains the information read from the ID tag 184 on the container 24 and transmits the signal to the controller 200. The tag reader 180 can also generate a status signal comprising a container void signal which would indicate if the container is defective or otherwise void, for example, if the container has already been used.

A sample sensor 190, which may be an optoelectronic sensor having a beam source 191a that transmits an optical beam 194 to a facing beam receiver 191b. When sample 22 is gradually added to the container 24 it eventually breaks the optical beam 194 which causes the sample sensor to generate a status signal comprised of a sample signal to the controller 200 indicating that the presence of a sample 22 in the container has been detected. The amount or volume of sample 22 introduced into the container 24 can also be detected when the source and receiver 191a,b being mounted facing each other near a sample end 192 of the receptacle 44 at a height corresponding to the desired sample level 193. The sample sensor 190 can also be a weight detecting sensor 195 mounted on the surface 84 of the receptacle 44 that is directly below the container 24 to detect the weight of the resting container 24, such as a piezoelectric pressure sensitive devices, as shown in FIG. 5. By sample level 193 it is meant a level of fluid, or a weight of sample 22, that is received in the container 24. Optionally, the sample sensor 190 can also perform a calibrated measurement of the amount of sample 22 actually received in a container 24 and generate a signal in proportion to the amount of sample 22 that is outputted as the sample signal. When a container 24 that is initially inserted into a receptacle 44 already has sample into or is not clean, the sample sensor 190 can also generate a sample signal that indicates an error, namely that the inserted container is not empty.

A controller 200 is provided to control operation of the restraint 104 and other systems and hardware of the sample collector 20, as shown in FIG. 8. Typically, the controller 200 comprises a computer 204 having a central processing unit (CPU) 208, such as a Pentium processor commercially available from Intel Corporation, Santa Clara, Calif., coupled to a memory 210 and peripheral computer components. The memory 210 may include a removable storage 212, such as a CD, floppy drive, or flash memory; a non-removable storage 214, such as a hard drive; and random access memory (RAM) 216. The controller 200 may further comprise a hardware interface 218 comprising analog or digital input and output boards, motor controller boards, and solenoids. An operator can communicate with the controller 200 via a display 220 and data input device 222. To select a particular screen or function, the operator enters the selection using the data input device 222, which may be a keyboard or light pen. An input output (IO) hub 224 is provided to receive and transmit signals to the external environment, and has various conventional internal and external ports 226, 228, respectively. The controller 200 also interfaces through the IO hub 224 to a receptacle controller 230, which may be located in the computer or in the chassis 40 of the sample collector 20, and that contains hardware interface boards that can receive and send signals to a plurality of receptacles 44a,b, as schematically shown in FIG. 8.

The computer 204 can also communicate with an external host computer 232, which stores patient information, sample collection procedures, or even patient medical history and safety information. For example, in a hospital, a host computer 232 maintained at a central location in the hospital can be used to collect and store all patient and testing data, which is then made available to other local computers 204 through a local area network (LAN) or wide area network (WAN).

The controller 200 also comprises a computer readable program 250 stored in the memory 210. The computer readable program 250 comprises program code capable of evaluating received data signals and operating the receptacle components of the collector 20 by sending instructions via instruction signals. The computer readable program 250 may be written in any conventional programming language. Suitable program code is entered into single or multiple files using a conventional text editor and stored or embodied in computer-usable medium of the memory. If the entered code text is in a high level language, the code is compiled, and the resultant compiler code is then linked with an object code of pre-compiled library routines. To execute the linked, compiled object code, the user invokes the object code, causing the CPU to read and execute the code to perform the tasks identified in the program.

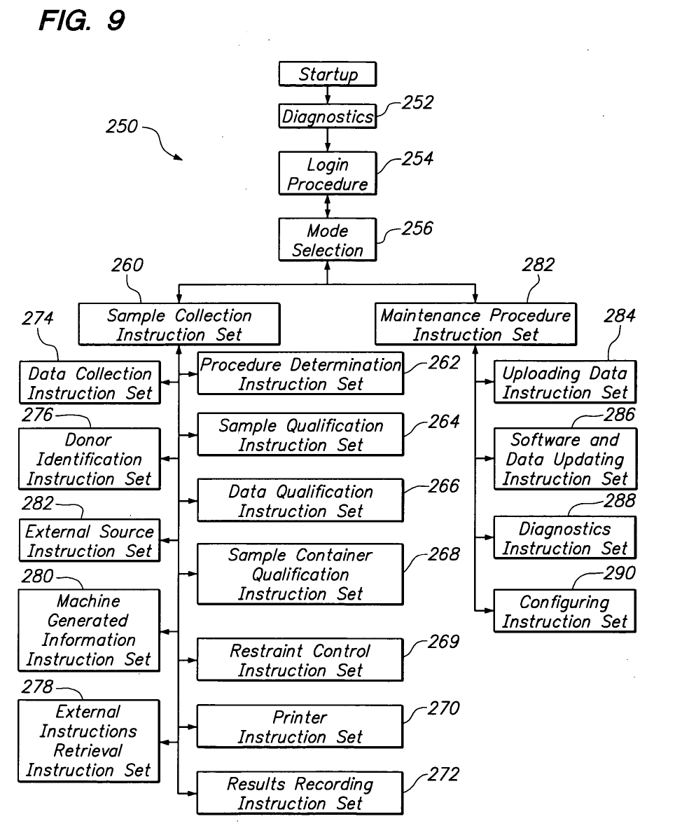

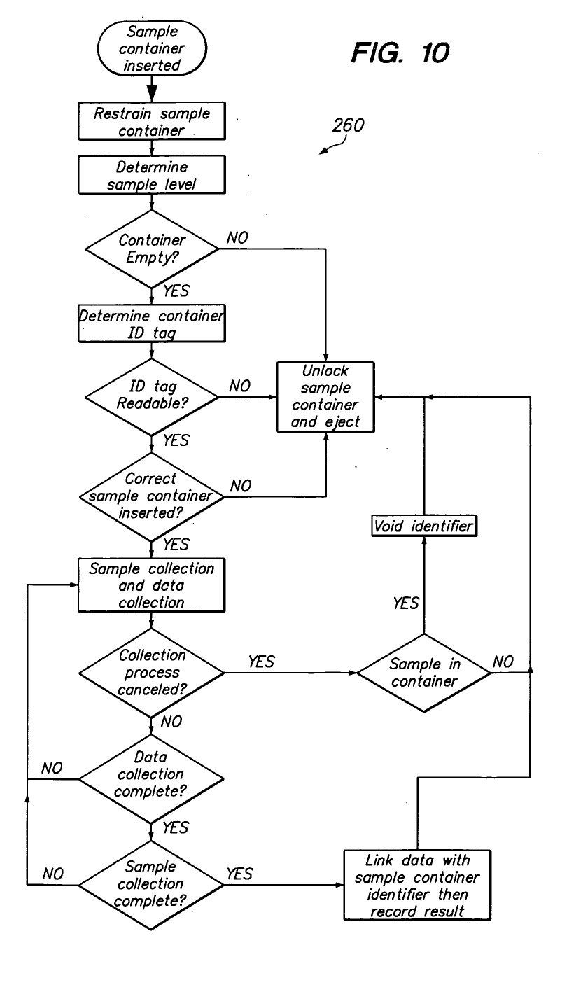

An illustrative control structure of an embodiment of a suitable computer readable program 250 is shown in FIG. 9. The program 250 controls the mechanical devices, sensors, and feedback displays 220 of the sample collector 20. The program 250 also communicates with externally attached devices, other computers, and generally manages the sample collection process. When initially activated, the program 250 begins by running a diagnostic instruction set 252 to determine if the sample collector 20 is functioning properly. Additionally, the diagnostic instruction set 252 determines the number and type of devices available both internally and externally. Next a login procedure set 254 is used to determine status of the operator, which can include the identification of the operator, the level of authority that the operator has for data access, sample collection, device configuration, and other operational procedures. The level of authority associated with a specific operator may be stored in a Look-up Table within the memory 210 accessible to the computer 204. Next a mode selection set 256 allows the operator to choose the mode of operation. Available modes include a sample collection mode and a maintenance procedures mode. Other modes can be added to facilitate the collection process if necessary. Additionally, the operator has the opportunity to set and change parameter settings for sample collection.

The sample collection instruction set 260 controls the sample collection process, an example of which is illustrated in FIG. 9. For example, the sample collection instruction set 260 can include instruction sets to perform the tasks of procedure determination 262, sample qualification 264, data qualification 266, sample container qualification 268, printer instructions 270, restraint control 269, and results recording 272. The sample collection instruction set 260 can also perform additional functions such as data collection 274, donor identification 276, external instructions retrieval 278, and machine generated information 280. The instruction set 260 can also perform further tasks, such as checking to see if an identified sample donor has additional outstanding requests for sample collection. The instruction set 260 also allows the operator to override steps in the sample collection procedure if the operator has been allowed these privileges.

The procedure determination instruction set 262 determines the sample collection procedure to be performed and returns information describing the requirements of the sample collection procedure from a Look-up Table to the sample collection instruction set 260. The Look-up Table can be stored in the memory 210 as local or removable memory, or on a network depending upon the frequency of updating required for sample collection procedures. A sample collection procedure can specify the number of samples 22 required, the type of containers 24 to be used, the data required to be associated with the sample 22, the level and amount of error correction, the method of results recording, and other parameters necessary to complete the sample collection process.

The sample collection procedure can be determined through a variety of methods. Three such methods are by default, by the operator, or by a Look-up Table. The specific method used to determine the sample collection procedure is specified during the mode selection 256 stage of the program 250 and can be further specified by an operator using the configuration instruction set 290. After the sample collection procedure is determined, the procedure determination instruction set 262 then looks up the requirements for the collection procedure and returns this information to the sample collection instruction set 260.

When a default sample collection procedure is specified the procedure determination instruction set 262 returns the default setting. When an operator determines the sample collection procedure the data input device 222 is used by the operator to indicate suitable choices. The sample collection instruction set 260 may indicate to the operator a list of possible collection procedures retrieved from a Look-up Table. The list of possible collection procedures can be limited by using information available to the program. For example, when a container 24 specific for a single or limited set of collection procedures has previously been inserted into the device then the list of possible collection procedures indicated to the operator can be limited by this container type.

When a Look-up Table is used to specify the collection procedure a variety of different methods can be used. These methods include querying a Look-up Table by a sample donor's identification, by non-donor specific information, by information generated from machine read forms, or by information delivered to the device from an external source. The specific method used to determine the sample collection procedure via a Look-up Table is specified during the mode selection 256 stage of the program and can be further specified by an operator using the configuration instruction set 290.

When the identity of a sample donor is used to determine the sample collection procedure, a Look-up Table containing collection procedures to be performed for specific sample donors is used. The identity of the donor is determined using the donor identification instruction set 276 and the Look-up Table is queried for uncompleted sample collection procedures associated with the specific donor.

When non-donor specific information is used to determine the sample collection procedure, a Look-up Table containing collection procedures to be performed for specific instances is used. Non-donor specific information can be a specific time of day, location, or other parameter that has been pre-assigned to determine a sample collection procedure. The non-donor specific information is determined and a Look-up Table is queried for the sample collection procedures associated with the specific non-donor specific information.

When machine generated information 280 is used to determine the sample collection procedure a Look-up Table containing collection procedures is used. The machine generated information that specifies the collection procedure is returned after executing the machine generated information instruction set 280. For example, a form is provided indicating the type of collection procedure to be performed. The form is machine read, translated, and the collection procedure indicated is returned.

The external instructions retrieval instruction set 278 is used to retrieve information from the memory 210 or an external source, such as the host computer 232, which is stored in an external Look-up Table containing sample collection procedures. The collection procedure information is returned after executing the external source information instruction set 278. For example, the host computer 300 can send a request for a specific sample collection procedure to the device by using a network connection. This triggers the external source instruction set 282 that then calls the external instructions retrieval instruction set 278.

The sample qualification instruction set 268 determines the completeness of sample collection as specified by sample collection procedure. The instruction set 268 collects information about the collected sample 22 and compares the readings to the sample collection procedure requirements. Information about the collected sample 22 can include the presence or absence of sample in a container 24, the level or amount of sample in the container 24 as indicated by the sample signal, and other parameters that may be required to insure a properly collected sample. For example, when a sample collection procedure requires a minimum level of sample to be collected. The sample qualification instruction set 268 would determine the sample quantity, compare it against the sample collection procedure specification, and return the results.

The data qualification instruction set 266 determines the completeness of data collection as specified by sample collection procedure. The instruction set 266 collects information about collected data and compares the information to the sample collection procedure requirements. This information can include the presence or absence of data, the quality or amount of data collected, the ID tag 184 of the sample container 24 indicated by the container tag signal, and other parameters that may be required to insure a properly collected sample 22. For example, when a sample collection procedure requires a minimum of data to be collected, the data qualification instruction set 266 would determine the data quantity, compare it against the specification, and return the results. The data qualification instruction set 266 generates a status signal comprising a data received signal that indicates whether data to be associated with a container 24 is received and complete.

The data collection instruction set 274 collects the data specified by the sample collection procedure. The instruction set 274 allows the operator to input the specified data by different ways including via keyboard, touch screen, machine readable forms, bar code scanner, thermometer, fingerprint scanner, blood pressure monitor, mouse, and other input devices. Information that is available to the collector 20 and does not require operator input is collected automatically. This includes status signals such as the container tag signal, the sample signal, and the container detector signal. Additional information may include the date, time, location, donor identification, information available via a network, and other values available to the collector 20.

The data collection instruction set 274 also uses error detection and correction methods to improve the quality of the data collected. The level and amount of error checking is specified by the sample collection procedure, by the mode selection 256 stage of the program, and can be further specified by an operator using the configuration instruction set 290. Error detection and correction methods can include the comparison of inputted data to expected ranges, the double checking of machine read forms by the operator, the double checking of machine read forms by an automatic system, the use of completion aids to help the operator when an input is incorrect but similar to an expected input, and by other error detection and correction methods.

The sample container qualification instruction set 268 determines the appropriateness of an inserted container 24 as specified by sample collection procedure. For example, the container qualification instruction set 268 can determine a status signal by evaluating a container received signal to determine if the container is properly received in the receptacle. The container qualification instruction set 268 can also determine a container type signal to determine the type of container that has been received in the sample receptacle by collecting information about the container 24 and comparing the readings to those specified by the sample collection procedure. Information about the container 24 can also include the presence or absence of sample 22 by determining a sample signal, a unique container identifier, the size or volume of the container, the manufacturer, the preloaded contents, the readability of the ID tag by determining a container tag signal, and other parameters that may be required to insure a properly collected sample 22. For example, when a sample collection procedure requires a container 24 with a minimum container volume, a unique ID tag, and for the container 24 to be empty, the sample qualification instruction set 268 determines these parameters, compare them against the sample collection procedure specifications, and return the results in the form of a status signal.

The restraint control instruction set 269 controls operation of the restraints 104. A status signal is determined by for example, the container qualification instruction set 268, sample qualification instruction set 264, data qualification instruction set 266, results recording instruction set 272, data collection instruction set 274, or other instruction sets. The status signal can indicate receipt of one or more proper containers 24 into the receptacles 44, filling of the containers 24 to the desired levels, determination of a proper label on a container 24, or other containers related signals. The restraint control instruction set 269 receives the status signal and in response to the status signal, sends to the restraint 104 anyone of (i) an open signal to set the restraint 104 to the open position, (ii) a lock signal to set the restraint 104 to the locked position, or (iii) a stand-by signal to maintain the open or locked position of the restraint 104. For example, if the status signal indicates that the wrong type of container 24 is received in a receptacle, the restraint control instruction set 269 sends to the particular restraint 104, an open signal to set the restraint to the open position if the restraint is already set to a locked position upon insertion of a container 24 into the receptacle 44, or a stand-by signal if the restraint 104 is already in the open position. Conversely, if the status signal indicates that the correct type of container 24 is received in a receptacle 44, the restraint control instruction set 269 sends to the restraint 104 a lock signal to lock-in the container 24. Similarly, when the status signal indicates that a sample, or the proper amount of sample has been received in the container 24, the restraint control instruction set 269 sends to the restraint 44 an open signal to open the restraint to open it and allow the container 24 to be removed from the receptacle 44. A another example would be when the status signal indicates a proper container, proper sample amount, proper data collection, proper restraint position, proper ejector position, proper blocker position, and proper results recording, the restraint control instruction set 269 then sends to the restraint 44 an open signal to open the restraint to open it and allow the container 24 to be removed from the receptacle 44.

The results recording instruction set 272 collects all available data from the sample collection device, program, and process and records this information as specified by the sample collection procedure. The instruction set 272 can generate a status signal comprised of a results recording signal that contains information on the outcome of the recording procedure. Available data can include results from the data collection instruction set 274, the data qualification instruction set 266, the sample qualification instruction set 264, the container qualification instruction set 268, the procedure determination instruction set 262, the diagnostic procedures 252, the login procedures 254, date, time, location, temperature, device serial number, or other available data.

The locations, medium, and methods of data recording are specified by the sample collection procedure. Recording locations can include internal and external locations relative to the device, removable and fixed hardware, across a network to a distant device, and other locations. Multiple locations for data storage may be specified. Recording mediums can include dynamic and static random access memory, magnetic media, optical media, printed media, and other media. Methods of data recording can include un-encrypted information, encrypted information, or a combination of the two. If specified by the sample collection procedure, external Look-up Tables, accessible via a network, are updated by the results recording instruction set 272. For example, if a sample collection procedure was completed as required by an external Look-up Table then this Look-up Table can be modified to indicate the procedure is complete.

If the sample collection procedure requires the generation of printed media the printer instruction set 270 is called. The printer instruction set 270 controls internal and external printing devices. The instruction set 270 can also convert data into different symbologies, which can include text, character based languages, one-dimensional bar codes, two dimensional codes, and other symbologies. The instruction set 270 can also encrypt data before sending it to the printing device. Format and control information for different printing devices is stored in a Look-up Table. When specified by the sample collection procedure the printer instruction set 270 may allow the operator the option for duplicate printing or other printing functions. For example, a sample collection procedure may require the generation of an ID tag or label to be affixed onto the container. This label is specified to display all the information collected during the sample collection process, in an encrypted format, and as a machine readable two dimensional code. The printer instruction set 270 would then encrypt the data, generates the two dimensional code, and instructs the printer to print the label.

The donor identification instruction set 276 determines the identity of the sample donor. The identity of the donor can be determined and inputted by the operator, an optical reader capable of scanning a donor's identity card or papers, a magnetic reader capable of reading a donor's identity card, a fingerprint reader capable of determining the donor's identity from fingerprints, and other devices. The method used to determine a donor's identity is specified by the mode selection 256 stage of the program and can be further specified by an operator using the configuration instruction set 290. The sample collection procedure can also specify a series of preferred methods and excluded methods for donor identification. Multiple methods of donor identification can be specified to insure the highest level of certainty of the donor's identity.

The machine generated information instruction set 280 collects information from external devices and translates this information into a usable format for the program. The collected information may be delivered by scanning of documents, wireless transmission from external devices, and other input methods. The method to be used is specified by the mode selection 256 stage of the program and can be further specified by an operator using the configuration instruction set 290. The sample collection procedure can also specify a series of preferred methods and excluded methods for machine generated information.

The external source instruction set 282 receives unsolicited information from external sources, such as the host computer 232. This information arrives without a query from the program. Information can arrive for a variety of purposes. These purposes include requests for specific collection procedures to be performed, updates for software, updates for Look-up Tables, and other information necessary to operate the device. When the information is received the instruction set determines the appropriate way to handle the data and calls the appropriate instruction sets.

The maintenance procedures instruction set 282 allows the operator to reconfigure the sample collection device and program, and can include instruction sets that perform the tasks of uploading data, software and database updating, diagnostics, configuration, and other tasks necessary for the operation and upkeep of the device. For example, the maintenance procedures instruction set 282 can include, for example, an upload data instruction set 284, software and database updating instruction set 286, diagnostic instruction set 288, and configuring system instruction set 290.

The upload data instruction set 284 transfers data from the controller's memory 210 to external computer memory such as that of the host computer 232 or other systems or devices. The instruction set 284 can also encrypt data to secure the data during the transfer. External memory systems and devices can include removable memory cards, removable memory media, and remote databases accessible using a communications network. The operator can select the method of data transfer and the destination of the data.

The software and database updating instruction set 286 allows the operator to check for updates, choose updates for download, and install updates. These updates can include modification of the sample collection procedure Look-up Tables, modification of configuration settings, modification of controller software, modification of user rights and privileges, and modification of other aspects of the device necessary for the operation of the device.

The diagnostic instruction set 288 allows the operator to test specific components of device and aids in the interpretation of the results. The instruction set 288 can also upload the results of diagnostic tests to an external device using a network.

The configuring system instruction set 290 allows the operator to configure procedures, data sources, printer settings, device configuration, encryption settings, communication protocols, and other settings necessary for the operation of the device.

### EXAMPLES

The following examples illustrate embodiments of the present invention, and methods of practicing the invention, but should not be used to limit the invention in scope or content. Other embodiments as apparent to those of ordinary skill in the art are included in the scope of the present invention.

### Example 1

A physician orders a sample collection for a specific test for a specific donor. This is recorded in a network accessible Look-up Table. The sample donor arrives at a sample collection facility. The donor is identified to the sample collection device and the sample collection procedure is identified. The sample collection procedure is carried out by the operator. In this system the operator does not need to know how the sample 22 is to be tested. The donor does not have to carry any forms that can be lost, and the operator does not need to know the personal identity of the sample donor if a non-name identification system is used. The privacy of the sample donor can be protected throughout the process with only the physician having access to the results of the test. In another configuration even the physician could be excluded from knowing the results of the test and only the donor could have access to the results.

An operator can control the collector 20 using a data input device 222 comprising control switches 300 that are mounted on a display panel of the collector 20, through data input entered from the device 222 itself, or through an external controller 200 that is in communication with the collector 20. The control switches 300 can send control signals to facilitate sample collection, and may include operational functions such as abort, void, yes, no, up, down, and power on/off. For example, one control switch 300 can serve as an abort button that sends an abort signal to the controller 200 to abort the sample collection procedure. Upon receiving the abort signal, the controller 200 sends instructions to a restraint 104 to maintain an open position to allow an operator to manually remove a container 24. The switches 300 can also be used in conjunction with the audio/visual feedback display 220 to program, test, and operate the collector 20. The operator can also enter data using the data input device 222 that communicates with the controller 200. The entered data is accepted and stored in a data Look-up Table of the memory 210 of the computer 204. The operator may enter the data in response to menus or screens displayed on the display 220 that are generated by a data collection instruction set 274 of the computer program 250. The controller 200 can also sends out control signals in response to received data signals or instructions signals. The control signals can be provided in different communication protocols, such as wireless protocols include WiFi/Airport, infrared/IrDA, and Bluetooth. Hard wired protocols include TCP/IP, USB, IEEE-1394, Ethernet, and other parallel and serial protocols.

In one version, the controller 200 receives a signal that includes information about at least one status signal (status signal). In response to the status signal, the controller 200 sends a control signal to the restraint 104, comprising either (i) an open-up signal to set the restraint 104 to the open position, (ii) a lock-up signal to set the restraint 104 to the locked position, or (iii) a stand-by signal to continue to maintain the open or locked position of the restraint 104. The controller 200 can operate the restraint 104 in response to the received status signal to ensure proper receipt of containers 24, identify an incorrectly received container, ensure collection of the proper amount of sample 22, insure proper collection of data, correlate data with the container, correct sample 22 identification, insure operator safety, and other functions.

The following examples illustrate different versions of the collector 20, however, other versions and other functions as would be apparent to those of ordinary skill in the art are within the scope of the present invention.

The sample collection process can be initiated in a number of different ways. For example, the operator can initiate the sample collection process by indicating the type of collection procedure to the controller 200, which would then display the number and type of containers 24 that need to be loaded into the collector 20. The operator can check an external source, such as for example, a patient record, list of outstanding sample or biometric information keyed to patient record, to determine the sample 22 requirements and the necessary collection procedure. This includes using the donor's identity to check for required collection procedures and/or authorize a procedure by confirming the identity of the patient. The donor's identity can be determined using a variety of methods including scanning a donor's identity card or identity bracelet, or using a biometric method.

The operator can also determine the type of collection procedure required from a hospital form filled out by a physician or nurse practitioner that indicates the type of sample 22 required and the associated collection procedure, and load the desired containers 24 into the sample 22 receptacle 44. When the form is machine readable, the operator presents the machine readable form to a form reader which scans the form and communicates with the controller 200 to determine the type of collection procedure needed. The form reader can be a scanner 304 to read the form and a text or table processor program to extract the needed information from the form. The machine readable form can also be structured similarly as a questionnaire, especially in situations where the donor may have to provide written agreement and/or consent for a procedure, such as in the form of a signature, the complete image of the signature, can be communicated to the controller 200. Further, complete images of each form can be communicated to and stored by the controller 200, and all this information can be associated with the container. The controller 200 decodes the form to determine the collection procedure or other data, displays the number and type of containers 24 that need to be loaded into the collector 20, and can also generate labels for the containers 24 or transmit information to the ID tags on the containers 24 to specify donor identification, analysis to be performed on sample 22, or other information about the sample 22.

In yet another method, the collection process is started when information is retrieved by the controller 200 from a host computer 232 upon entry of the sample donor's identification number or name by the operator. The operator can check an external source such as a patient record, list of outstanding samples, biometric information keyed to patient record or other sources, that indicates the patient identity or even the type of collection procedure that is necessary. The donor's identity can also be determined using a variety of methods including scanning a donor's identity card or identity bracelet, or using a biometric method.

Insertion of a proper container, or a set of containers 24, into the receptacle 44 of the chassis 40, can also initiate a collection procedure or may result in the controller 200 asking the operator for further data or other information before the collection procedure is determined. When containers 24 are placed in the receptacle 44, the container detector 96 of the collector 20 sends a container recieved status signal to the controller 200. The tag reader 86 then reads the ID tag on the container to determine the type or other identity of the container 24 and generates an appropriate status signal. The type and scope of the collection procedure is then determined by the operator and the controller 200 displays the number and type of containers 24 that need to be loaded into the collector 130.

After initiation of a collection procedure, the requisite number and type of containers 24 are loaded into the collector 20. When an empty container 24 is placed in a receptacle 44, the container detector 96 detects the presence of the container 24 and sends a status signal to the controller 200 that indicates proper receipt of the container. If the container 24 is not received properly, for example, not fully inserted in the receptacle 44, the detector sends a status signal indicating improper container receipt to the controller 200. The controller 200 evaluates the status signal for each container 24 and if any container 24 is not properly received, the controller 200 sends a control signal to the restraint 104 to cause the restraint 104 to open from a lock position, remain open, or open and eject the container. In one implementation, when an empty container 24 is placed in the receptacle 44 in the chassis 40, the container 24 is initially restrained in the receptacle 44 because the restraint 104 is of a type that automatically engages to a locked position when a container 24 is inserted in the receptacle 44. Thereafter, the container detector 96 determines if the container 24 is properly received in the receptacle 44 and sends a status signal to the controller 200. In another implementation, the restraint 104 remains in an open position when an empty container 24 is placed in the associated receptacle 44. Only after verification of the proper placement of the container 24 is the restraint 104 locked around the container. A control switch 300, designated as an abort switch, can also be provided so that an operator can activate the switch to send an abort signal to the controller 200, which upon receiving the abort signal opens the restraint 104 or keeps it open.

After a container 24 is placed in a receptacle 44, the tag reader 180 reads the ID tag 184 on the container 24 and sends a status signal containing the read-in information to the controller 200, which evaluates the information by comparing it to data stored in a Look-up Table, and then sends a control signal to the restraint 104 and optional ejector, in relation to a determination of a status of the container. For example, the restraint 104 may be set to the locked position by a lock-up control signal from the controller 200 after the controller 200 determines from the status signal that the ID tag 184 identifies the correct type of container, or that the ID tag 184 contains correct information for the associated sample 22 to be inserted in the container. Alternatively, the container 24 is released or ejected when the status signal indicates that the type or information on the ID tag 184 of the container 24 is unreadable, the container 24 is of the incorrect type for the required collection procedure, or the ID tag 184 of the container 24 bears a unique identifier that lists the container 24 to be unacceptable, for example, voided from another process or already filled.

After proper receipt and identification of a container, a yellow light signal is provide to the operator who then starts the sample 22 retrieval process from a donor. For example, when blood is to be collected from a person, the operator inserts a butterfly needle into a vein of a donor. The needle is connected to a tube that has a device to puncture the seal of the container 24 at the opposite end. Sub-atmospheric pressure in the container 24 facilitates the flow of blood from the donor into the container. After sample 22 is received in a container, the sample sensor 190 generates a sample 22 status signal that indicates whether a container 24 has received sample 22 and sends it to the controller 200. The sample status signal can also indicate the level of the sample 22 received in the container. When sufficient sample 22 is collected, as determined by the controller 200 comparing the actual sample level to a desired level in a Lookup Table, the controller 200 indicates a status of completion for the container 24 by activating a green light near a particular container 24. The controller 200 can also activate the red light near the container, for example, by flashing the light, and send a signal to release or eject the container 24 when the sample level sensor determines a non-zero amount of sample 22 present for a container 24 that is expected to be empty. The controller 200 evaluates the sample level signal by comparing the measured sample level signal to a desired sample level value in a Look-up Table for that particular type container 24 or future analysis of the container. The Look-up Table contains previously entered or stored sample levels that are each associated with a particular container, particular analysis, or which are specifically entered or received for the particular container 24 in the receptacle 44. A separate set of parameters for sample collection completion is used in particular instances where a sample 22 that needs to be collected does not fit into standard collection procedures, for example, when the sample 22 are being collected for outside processing (unique labeling requirements), for the transfer of sample 22 already collected into a new container, or when an operator overrides conventional procedures to apply a special procedure.

The controller 200 may also receive a status signal that indicates whether data to be associated with the container 24 has been received. This is an important feature to reduce errors in sample 22 identification when multiple sample are received in the collector 20, especially in a field environment. In this version, when an operator activates the collector 20, the controller 200 requests the data that is to be associated with the sample 22, at the onset of sample collection, during sample collection, or afterwards. For example, in one version, when a number of containers 24 are placed in the receptacle 44, the display can show a request for “sample identification” and provide data fields corresponding to the number of received containers 24. The associated sample 22 ID data fields may include, for example, donor identity and ID number, location, and tests to be performed. In more complex scenarios, for example in field sample collection during a disease outbreak of unknown origin, the number of associated data fields may number in the tens to hundreds with each field containing complex responses. After the requisite information is entered, the computer program of the controller 200 records a status signal that indicates completion of data entry. This signal may be used as a trigger to release or eject the containers 24 when the sample collection process is completed assuming all other sample collection procedures and statuses have been completed. In another version, the controller 200 requests for, and receives data from a networked source or host computer, after the operator enters a donor ID name or number, and upon receipt of the data, records the appropriate data received signal. The controller 200 may also, upon command from the operator, send control signals to a printer to instruct the printer to print out the data entry fields as on label feedstock for fixing as labels on the filled containers 24.

The containers 24 in the receptacle 44 are released by the controller 200 upon completion of sample collection, and an optional data received status, by setting the restrain to the open position, and optionally, activating the ejector springs to eject the containers 24. The containers 24 may also be released only after the controller 200 verifies completion of the sample collection process which is determined by the sample level status signal, the data acquisition and association signal, and other status signals that may be required by specific sample collection procedures. Additional requirements for container release may include that a proper identifier label has been affixed to the container, and optionally, determination that the information entered on an identifier label is correct. Information can also be printed directly onto the container 24 automatically, by the operator, or through the uploading of data onto a RF tag that is associated with the container. Color printing allows for more options when adding information to a container. When privacy issues are important the identifier label can also be encrypted to protect the donor's identity, sample 22 type, or testing purpose. The sample 22 identifier labels can be printed by the controller 200 using a conventional printer, and thereafter attached to each container 24 by the operator.

The collector 20 can use a document scanner 304 to communicate information to the controller 200. This information can be scanned forms, documents, or images that pertain to the type of sample collection procedure or to the sample themselves. Information contained on the forms can be recorded as digital images or can be interpreted. This information would be linked to the container's unique ID and/or to the sample donor's ID. An example of interpretation is when a form, containing a series sample collection procedures followed by boxes for check marks, is scanned and converted from the image into a signal to the controller 200 to perform the specific collection procedures indicated by the check marks. The scanner 304 can be built into the collector 20, mounted near the collector 20 and in communication with collector 20, or in communication with an external controller 200.

A digital camera can be used to communicate information to the controller 200. The digital camera can provide images of the sample donor or associated information relevant to the sample collection procedure. This information would be linked to the container's unique ID and/or to the sample donor's ID. The camera can be built into the collector 20, mounted near the collector 20 and in communication with collector 20, or in communication with an external controller 200.

The controller 200 may also determine the location of receipt of a particular sample 22 or set of sample, and store the information in an associated Table in the memory. A global positioning system (GPS) can be connected to the controller 200 to provide appropriate geographical coordinates, or alternatively, the controller 200 can also request location coordinates from the operator.

The controller 200 can also be connected to a biometric sensor for biometric data collection that also communicates with the controller 200. The biometric sensor can scan fingerprints, retinal scans, digital photos, or can even determine a combination of weight, height, or shape of individual. The biometric data signal can be used by the controller 200 to determine or verify the identity of a sample donor using stored data or by comparing the biometric data to data retrieved from an external host computer. Biometric data can also be used to regulate operator access to the controller 200—similar to a password.

The controller 200 can also have the ability to control other devices, such as for example, but not limited to scanners, bar code readers, printers, digital cameras, keyboards, scales, thermometers for external environmental and internal sample donor measurements, other devices that characterize the sample donor or environment, finger print readers, iris readers, and other biometric devices. A variety of communication protocols can be employed to this purpose including, wireless protocols such as WiFi/Airport, infrared/IrDA, and Bluetooth; hard wired protocols such as TCP/IP, USB, IEEE-1394, Ethernet, and other parallel and serial protocols. For example, the controller 200 can be connected to a hand operated bar code scanner can be used to confirm information of a patient or donor as determined by a scan of the persons ID tag.

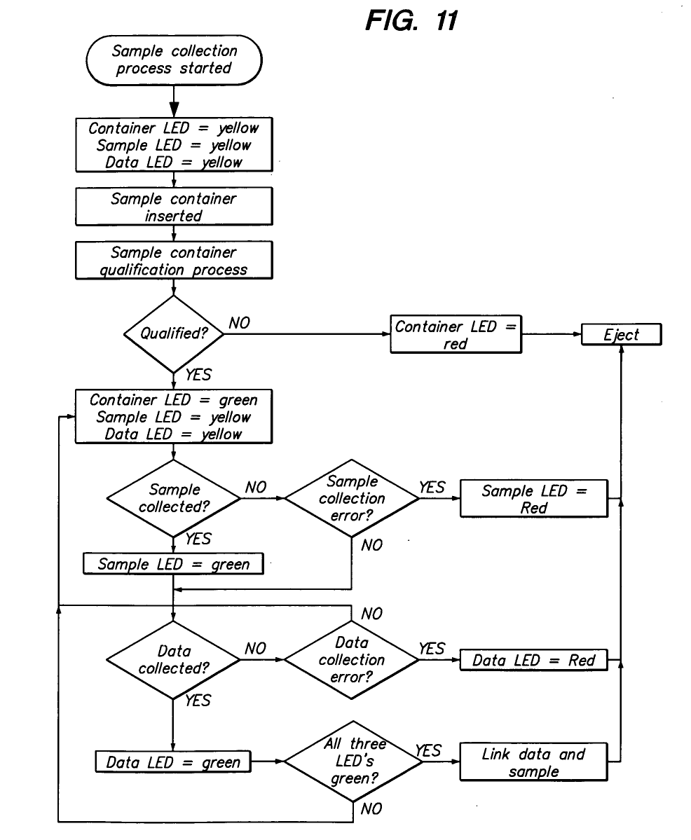

The controller 200 can also provide various visual and auditory signals to indicate the progress and status of the collection process, using light emitting diodes (LED) or text and graphs on the display 220 as shown in FIG. 11. For example, a simple visual representation could consist of three LEDs 306 each capable of generating a red, yellow, or green color, placed near the opening of each receptacle 44. Each LED would indicate the status of a different part of the collection process, with the first LED indicating the status of the receptacle 44 for receiving the container, the second LED indicating the status of sample collection, and the third LED indicating the status of data collection. The color green can indicate a state of completion, yellow—a state of waiting, and red—an error. For example, the LED can operate as an error indicator that receives an error signal and indicates an error mode when an incorrect sample container 24 is inserted into a receptacle, the container 24 contains sample, or the container 24 is improperly placed. Sound generation can also be used to indicate progression of the collection process, errors, or draw attention of the operator to a particular state of the collector 20. Graphical and text based information can be used to provide detail about the collection process or to display tree-structured menus for operation.

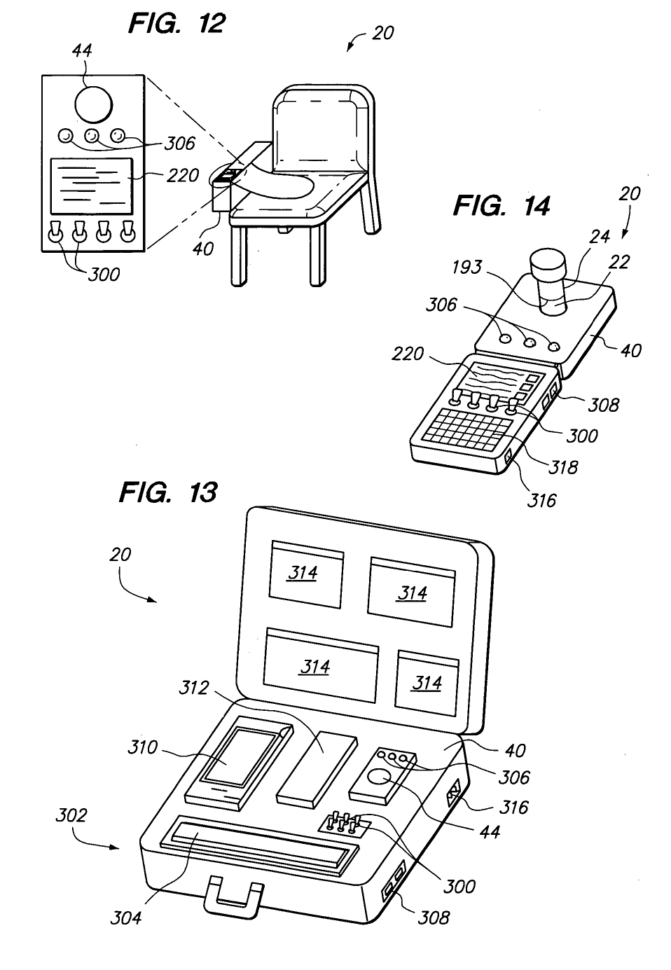

The sample collector can be a mobile station, as shown in FIG. 1, that can be carried to a bedside in a hospital to facilitate the bedside collection of a sample, or placed on a table by a patient's chair in a clinical laboratory. The sample collector 20 can also be fixed to a solid surface to facilitate the collection process. A variety of methods can be used including straps, bolts, suction devices, magnetic holders, and/or high friction pads. For example, the chassis 40 of the collector 20 can be fitted onto a mobile cart and a PC is provided on the cart to control the collector. A portable power source may also be fitted into the mobile cart (not shown). The collector 20 can also be integrated into a piece of furniture, such as a desk, chair (FIG. 12), or counter top. Integration can be advantageous to the collection process when the donor of a sample 22 feels uncomfortable around medical devices.

In the hospital or blood collection laboratory, the collector 20 can be used in a fixed station, such as a phlebotomists station in a hospital or clinical lab, as shown in FIG. 12. In this version, the collector 20 comprises a controller 200 that is a personal computer to control the apparatus, and can be mounted near or in the phlebotomists chair. The apparatus PC can also be networked with a local area network (LAN) to receive and distribute data via a wireless or hardwire connection such as the WiFi protocol or Ethernet protocol. The fixed station collector can also be mounted on a floor stand with legs that are sized to allow an operator easy access to the controls and sample 22 receptacle 44. The floor stand can also have a working table area to receive papers and other items.

In the field environment, when it is necessary to collect sample from humans, animals, or the environment, the collector 20 is mounted in a field station unit, as shown in FIG. 13. The field station unit comprises the majority of controlling functions that otherwise might be left to an external personal computer. Size and power consumption would be minimized to facilitate portability and extended use away from power sources and other information infrastructure. An example of this would be an increase of the internal memory storage capacity of the device and the addition of internal rechargeable batteries 312. A portable carrying case 302 can enclose all the elements necessary to complete the collection process. One preferred carrying case 302 can be a briefcase into which is mounted the core elements of the controller 200, the computer 204, the collector, and the power supply (battery pack) 312 with additional devices such as a scanner 304, a label printer, or other devices enclosed as needed. Storage spaces 314 can be provided for unfilled and filled containers 24, printer consumables, and other materials needed for the collection process. Power ports 316 and data ports 308 can be included on the side of the enclosure to facilitate recharging of the power supply and transfer of data. The collector 20 is self-contained with a controlling interface and data ports 308 mounted on the chassis 40 of the collector. A controller 200 that is a laptop or portable digital assistant (PDA) 310 device can be used to facilitate data entry and association with the proper sample. Portable power supplies, such as a battery pack 312, can also be used to power the collector 20 and controller 200.

When sample collection requires a highly mobile operator the collector 20 can also be in the form of a hand held device, as shown in FIG. 14. One version involves a hinged device (similar in shape to a flip mobile phone). When opened, the device exposes a region for inserting and restraining containers 24. A display 220 is provided to display information about the collection process. An input device, such as a thumb sized keyboard is used to enter information about the collection process, the sample collected, and to control the sample collector 20.

The present invention has been described in considerable detail with reference to exemplary versions thereof, however, other versions are possible, as would be apparent to one of ordinary skill in the art. For example, other arrangements of the sample collector 20 can also be used depending on the application. Also, alternative restraints can be designed, for example, another type of restraint could employ a system of latches to lock into a groove in the body of the container. Further, relative terms, such as first and second, inner and outer, top and bottom, if used, are provided only to illustrate the invention and are interchangeable with one another. Therefore the spirit and scope of the appended claims should not be limited to the description of the preferred versions contained herein.

In the claims:

1. A sample collector comprising:
(a) a chassis;
(b) one or more receptacles in the chassis, each receptacle capable of receiving a container;
(c) a restraint about each receptacle to restrain a container in the receptacle, the restraint having (i) an open position which allows a container to be inserted into, or released from, the receptacle, and (ii) a locked position in which a received container cannot be removed from the receptacle; and
(d) a controller to receive a status signal and in response to the status signal, send to each restraint (i) an open signal to set the restraint to the open position, (ii) a lock signal to set the restraint to the locked position, or (iii) a stand-by signal to maintain the open or locked position of the restraint.

2. A sample collector according to claim 1 wherein the restraint comprises a clamp that grips a sidewall of the container, the clamp being biased against the container by a spring.

3. A sample collector according to claim 2 wherein the restraint comprises a pair of clamps that grip opposing sides of the sidewalls of a container, each clamp comprising a gripping pad.

4. A sample collector according to claim 3 wherein each gripping pad is connected to a lever and that pivots on a spring arm, the spring arm is biased toward the container sidewall by a spring within a solenoid, the solenoid being capable of retracting the spring arm when activated.

5. A sample collector according to claim 1 wherein restraint comprises a locking pin inserted into a corresponding locking slot, the pin and slot being positioned on matching portions of the container and receptacle.

6. A sample collector according to claim 5 wherein the locking pin is biased against the container by a locking spring, and wherein the locking pin is retracted by an electromagnetic solenoid powered by an electromagnetic power supply.

7. A sample collector according to claim 1 comprising a blocker to block insertion of a container in the receptacle.

8. A sample collector according to claim 1 wherein the blocker comprises the restraint in the locked position.

9. A sample collector according to claim 1 wherein after each container is placed in a receptacle, the controller receives a status signal comprising at least one of:
(1) a container received signal which indicates if a container is properly received in the receptacle;
(2) a container tag signal which identifies the container received in the receptacle;
(3) a container void signal which indicates that the container is inappropriate; and
(4) a sample signal that indicates that the container is not empty.

10. A sample collector according to claim 9 comprising a tag reader to read an ID tag on a container received in a receptacle and generate the container tag signal or the container void signal.

11. A sample collector according to claim 10 wherein the tag reader comprises at least one of:
(i) an optical sensor that scans the ID tag associated with the container with a laser beam that rapidly scans though a fixed viewing angle;
(ii) a bar code reader that reads the ID tag comprising a set of bar codes on the container; or
(iii) a RF tag reader that reads a RF ID tag associated with the container.

12. A sample collector according to claim 9 comprising a container detector capable of detecting the presence of a container in the receptacle and generating the container received signal.

13. A sample collector according to claim 12 wherein the container detector comprises a touch or pressure sensitive device, the device being mounted about the internal surfaces of the receptacle.

14. A sample collector according to claim 13 wherein the container detector comprises a paired beam source and beam receiver, the beam source capable of generating an optical beam that passes through the receptacle to be received by the beam receiver.

15. A sample collector according to claim 1 wherein the controller maintains the restraint in an open position, sends an error signal, or ejects a container, when the received status signal:
(i) a container received signal that indicates improper placement of the container;
(ii) a container tag signal that indicates that an incorrect or voided container has been received; or
(iii) a sample signal that indicates that the container is not empty.

16. A sample collector according to claim 15 comprising an ejector within the receptacle to eject an inserted container.

17. A sample collector according to claim 16 wherein the ejector comprises a compressible ejection spring located at the bottom portion of the receptacle.

18. A sample collector according to claim 16 wherein the ejector generates a status signal containing information about the position and status of the ejector

19. A sample collector according to claim 1 wherein the controller receives a status signal comprising a data received signal which indicates whether data to be associated with a container has been received.

20. A sample collector according to claim 1 wherein the controller receives a status signal comprising a sample signal that indicates if a sample has been received in a container, and sends instructions to the restraint to maintain an open or closed position depending on whether sample has been received in the container.

21. A sample collector according to claim 20 wherein the controller receives a status signal comprising a sample signal that indicates the amount of a sample received in a container, and sends instructions to the restraint to:
(i) maintain an open position if the sample amount in a container matches a sample requirement; or
(ii) maintain a locked position if the sample amount in a container does not match a sample requirement.

22. A sample collector according to claim 21 comprising a sample sensor capable of generating the sample signal from the level or weight of a sample received in a container.

23. A sample collector according to claim 1 comprising an abort button to send an abort signal to the controller which upon receiving the abort signal sends an open signal to open a restraint.

24. A sample collector according to claim 1 wherein the receptacle and container have matched asymmetric shapes.

25. A sample collector according to claim 1 wherein the receptacle and container have matched orientation slots and tabs.

26. A sample collector according to claim 1 further comprising a shield mounted on the chassis, the shield being shaped and sized to allow an operator to view a container while obscuring the view of the container from the sample donor.

27. A sample collection method comprising:
(a) receiving a container;
(b) restraining the container;
(c) providing a sample in the container; and
(d) releasing the container only after sample is received in the container.

28. A method according to claim 27 wherein (b) comprises activating a restraint to grasp the sidewalls of the container.

29. A method according to claim 27 wherein (b) comprises activating a restraint to cause a locking pin to enter a locking slot about the container.

30. A method according to claim 27 wherein (d) comprises detecting an increase in weight of the container to determine a sample has been provided in the container.

31. A method according to claim 27 wherein (d) comprises detecting an amount of a sample in the container, comparing the detected sample amount to a stored or predetermined sample amount, and releasing the container if the detected and stored or predetermined sample amounts are substantially the same.

32. A method according to claim 27 comprising releasing the container after data pertaining to the sample is received.

33. A method according to claim 27 comprising releasing the container after reading an ID tag affixed to the container and determining if the information on the ID tag has been correctly entered.

34. A method according to claim 27 comprising releasing the container after reading an ID tag on the container, determining if the amount of sample provided in the container matches a predetermined sample amount, determining if the ID tag indicates the proper information relating to the sample and donor, and linking a unique identifier in a stored memory table with the sample amount and ID tag.

35. A method according to claim 27 comprising releasing the container upon determining that
(1) the container is not properly received;
(2) an inappropriate container is received,
(3) the container is defective; or
(4) the container is not empty.

36. A method according to claim 35 wherein (1) comprises determining the position of the container in a receptacle with a contact or pressure-sensitive sensor.

37. A method according to claim 35 wherein each container has an ID tag, and wherein (2) comprises reading the ID tag on the container and comparing the read information with stored information to determine if the container is the appropriate container.

38. A method according to claim 35 wherein each container has an ID tag, and wherein (3) comprises reading the ID tag on the container to determine a void marker on the container.

39. A method according to claim 35 wherein (4) comprises detecting a sample in the container.
